(19) United States
(12) Patent Application Publication
(10) Pub. No.: US 2017/0177651 A1
(43) Pub. Date: Jun. 22, 2017

(54) APPLYING TACIT KNOWLEDGE TO ITERATIVELY REFINE DATASETS

(71) Applicant: International Business Machines Corporation, Armonk, NY (US)

(72) Inventors: Jason B. Ellis, New York, NY (US); Thomas D. Erickson, Minneapolis, MN (US); Peter K. Malkin, Yorktown Heights, NY (US); Kevin P. McAuliffe, Yorktown Heights, NY (US)

(21) Appl. No.: 14/974,558

(22) Filed: Dec. 18, 2015

(51) Int. Cl. G06F 17/30; G06F 17/24

(52) U.S. Cl. CPC G06F 17/30371; G06F 17/241; G06F 17/30525

(57) ABSTRACT

An aspect of applying tacit knowledge to iteratively refine datasets includes determining, via a computer processor, that a data element in the dataset is potentially in non-conformance with other data in the dataset. The potential non-conformance is determined based on a discrepancy in a pattern noted in the dataset with respect to the data element. The dataset spans multiple knowledge domains. An aspect also includes annotating a data structure containing the data element to indicate the potential non-conformance and providing, via a user interface of the computer processor, a plurality of users with access to the data structure. The users collectively indicate domain experts for each of the multiple knowledge domains.

### BACKGROUND

The present disclosure relates generally to information processing. More specifically, the present disclosure relates to applying tacit knowledge to iteratively refine service-delivery datasets to improve decision-making and outcomes.

In a service-delivery environment, datasets are typically large, interrelated and dynamic sets of data that are used over long periods of time (e.g., weeks, months, or years) to deliver services and to support other processes. An example of a service-delivery dataset is a collection of patient records and related public health/safety records that are used in the delivery of health and social services.

### SUMMARY

Embodiments are directed to a method, system, and computer program product for applying tacit knowledge to iteratively refine datasets in a coordinated care delivery system. The method includes determining, via a computer processor, that a data element in a dataset is potentially in non-conformance with other data in the dataset. The potential non-conformance is determined based on a discrepancy in a pattern noted in the dataset with respect to the data element, the dataset spanning multiple knowledge domains. The method also includes annotating a data structure containing the data element to indicate the potential non-conformance, and providing, via a user interface of the computer processor, a plurality of users with access to the data structure. The users collectively include domain experts for each of the multiple knowledge domains.

Additional features and advantages are realized through the techniques of the invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as embodiments is particularly pointed out and distinctly claimed in the claims at the conclusion of the specification. The foregoing and other features and advantages of the embodiments are apparent from the following detailed description taken in conjunction with the accompanying drawings in which:

FIG. 1 depicts a cloud computing environment according to an embodiment;

FIG. 2 depicts abstraction model layers according to an embodiment;

FIG. 3 depicts a diagram of a system for providing coordinated care delivery according to an embodiment;

FIG. 4 depicts a flow diagram for providing coordinated care delivery according to an embodiment; and

FIGS. 5A-5C depict user interface screens for providing coordinated care delivery according to an embodiment.

### DETAILED DESCRIPTION

Embodiments include providing coordinated care delivery through the application of tacit knowledge to iteratively refine service-delivery datasets in a service-delivery environment. The refinement of the service-delivery datasets can improve decision-making and outcomes. These datasets are often accessed, updated, and viewed by domain experts across multiple different knowledge domains. For example, considering a group that facilitates social and health care services for members of a community, the domain experts may include individuals having knowledge in the medical field, social care, education, and law enforcement, to name a few. A given subject of a dataset, e.g., a patient, can be associated with a vast amount of information from many different data sources. The exemplary coordinated care delivery described herein enables individuals having domain expertise across a multitude of different knowledge domains to collaborate on the refinement of particular datasets when it is determined that any data in the datasets is incorrect, missing, or otherwise is believed to lack conformance with other data in the dataset. The coordinated care delivery processes provide an interface in which domain experts can input, view, update, and refine data in a dataset.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

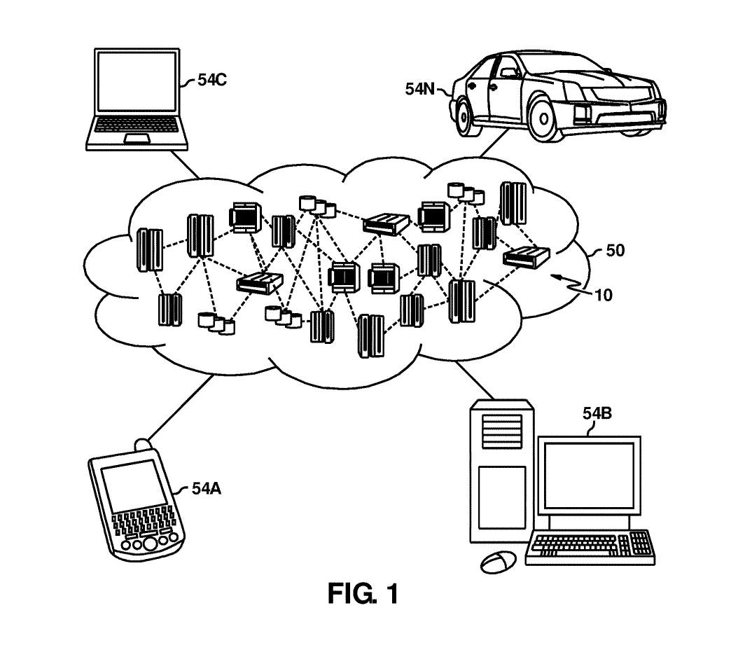

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

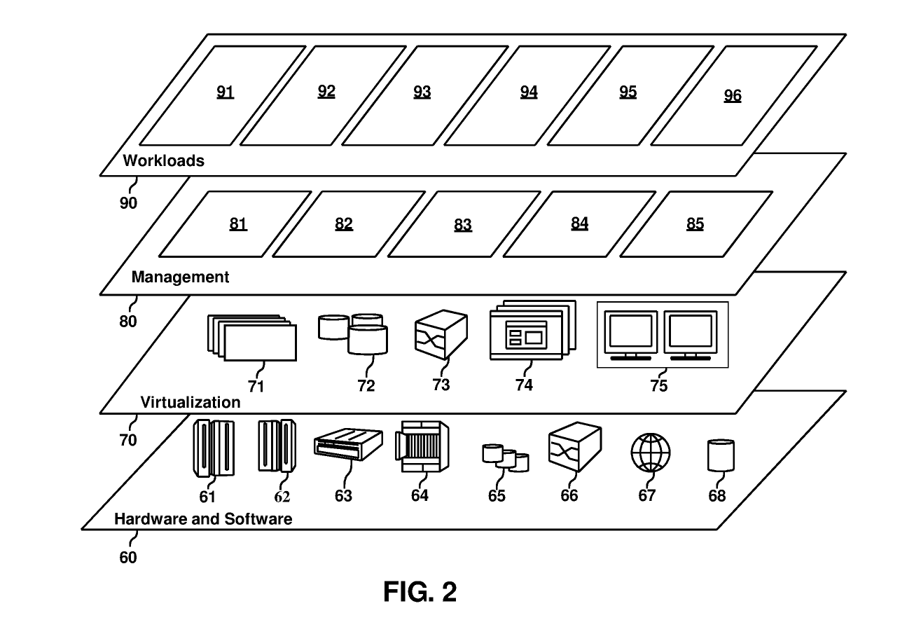

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and coordinated care delivery 96.

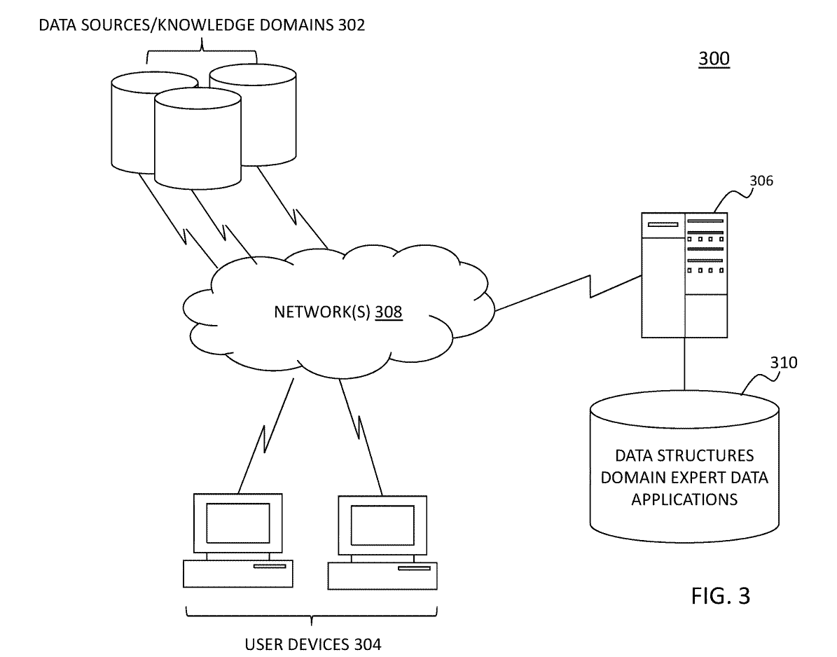

Turning now to FIG. 3, a system 300 upon which coordinated care delivery may be implemented will now be described in accordance with an embodiment. While embodiments are described herein as being directed to coordinated care delivery in a health care/social care environment for purposes of illustration, it will be understood that other areas and industries may be benefit from the coordinated care delivery processes described herein. For example, urban infrastructure planning may require many different domain experts in different fields to collaborate on a building or development project.

The system 300 of FIG. 3 includes storage devices 302, user devices 304, and a host computer 306, each of which is communicatively coupled to one or more networks 308. The storage devices 302 include databases of datasets that collectively span multiple knowledge domains. Using the example above with respect to health and social care, one set of storage devices may store public safety records, another set of storage devices may store patient medical records, and another set of storage devices may store social care records with respect to members of a community. In an embodiment, the storage devices 302 may be part of a network platform that is managed through one or more management applications. For example, in the health and social care fields, the management applications may include Cúram® software solutions offered through IBM®.

The user devices 304 (e.g., computing devices 54) may be used by domain experts who are tasked with facilitating the care of an individual and/or household. The domain experts may be professionals who are educated and/or skilled in providing various tasks that are associated with the care. Using the health and social care example above, the domain experts operating the user devices 304 may include physicians, nurses, social workers, public safety officers, and educators. Each of the user devices 304 may be implemented as personal computers (e.g., desktop, laptop) or may be portable devices (e.g., smart phones, tablet computers, personal digital assistants, etc.). The user devices 304 access the host system computer 306 to view, and in some embodiments provide input to, a data structure developed for a particular subject (e.g., an individual and/or household) via a user interface.

The host system computer 306 may be implemented as a high-speed computer processing device capable of handling the volume of activities conducted between the user devices 304 and the storage devices 302. The host system computer 306 may be operated by an entity that provides the coordinated care delivery as a service to others. For example, the host system computer 306 may execute one or more applications to coordinate with the storage devices 302, as well as the user devices 304, to generate data structures f or the datasets and provide an interactive view of the data structures to the domain experts via, e.g., the user devices 304. A storage device 310, which stores the data structures, domain expert information, and applications (e.g., coordinated care delivery 96), is accessible by the host system computer 306 for facilitating the coordinated care delivery described herein.

The storage device 310, as well as storage devices 302, may be implemented using a variety of devices for storing electronic information. It is understood that the storage device 310 may implemented using memory contained in the host system computer 306 or it may be a separate physical device, as illustrated in FIG. 3. The storage devices 302 and 310 may be logically addressable as consolidated data sources across a distributed environment that includes one or more networks, such as networks 308. Information stored in the storage devices 302 and 310 is retrieved and manipulated via the host system computer 306, as well as by end users of the coordinated care delivery processes.

The networks 308 may be any type of known networks including, but not limited to, a wide area network (WAN), a local area network (LAN), a global network (e.g. Internet), a virtual private network (VPN), and an intranet. The networks 308 may be implemented using wireless networks or any kind of physical network implementation known in the art, e.g., using cellular, satellite, and/or terrestrial network technologies. The networks 106 may also include short range wireless networks utilizing, e.g., BLUETOOTH™ and WI-FI™ technologies and protocols.

While the system 300 of FIG. 3 illustrates an embodiment in which the host system computer 306 implements applications for performing the coordinated care delivery described herein, it will be understood that at least a portion of the applications can be resident on and executable by the user devices 304. In addition, only three storage devices 302 and two user devices 304 are shown in the FIG. 3 for ease of illustration; however, it will be understood that any number of these devices can be employed in order to realize the advantages of the embodiments described herein.

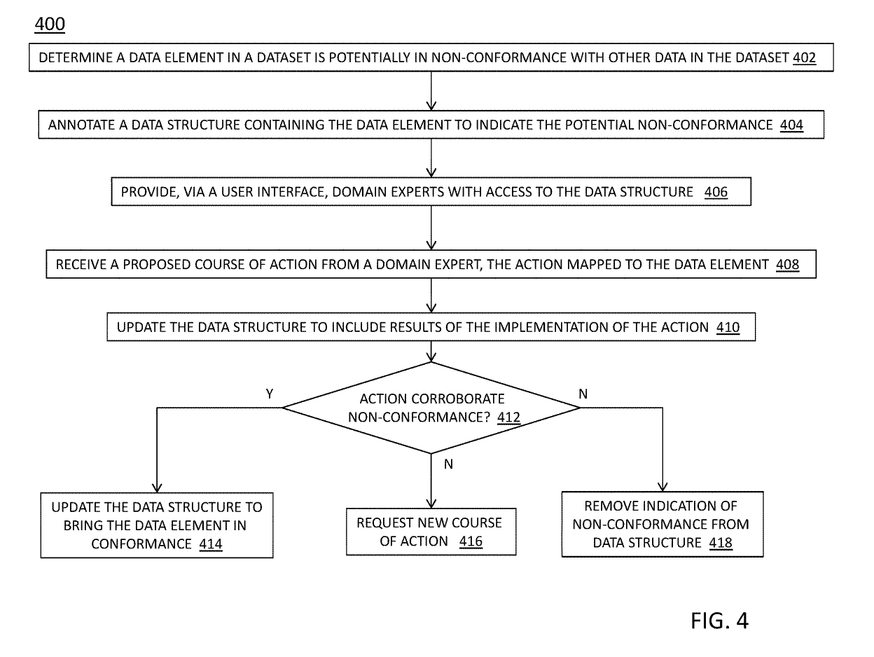

Turning now to FIG. 4 a data flow diagram of a process for implementing the coordinated care delivery will now be described in an embodiment. The following description is illustrative of coordinated care delivery in the health/social care industries in which a team of professionals is tasked with the care of an individual and/or household. The process of FIG. 4 assumes that one or more datasets for a subject are under review and that the dataset(s) span multiple knowledge domains.

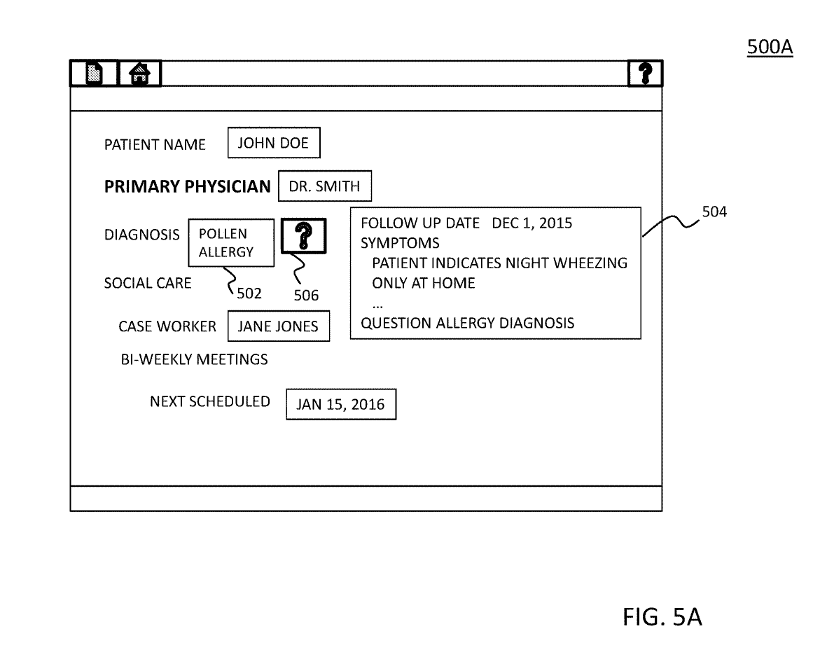

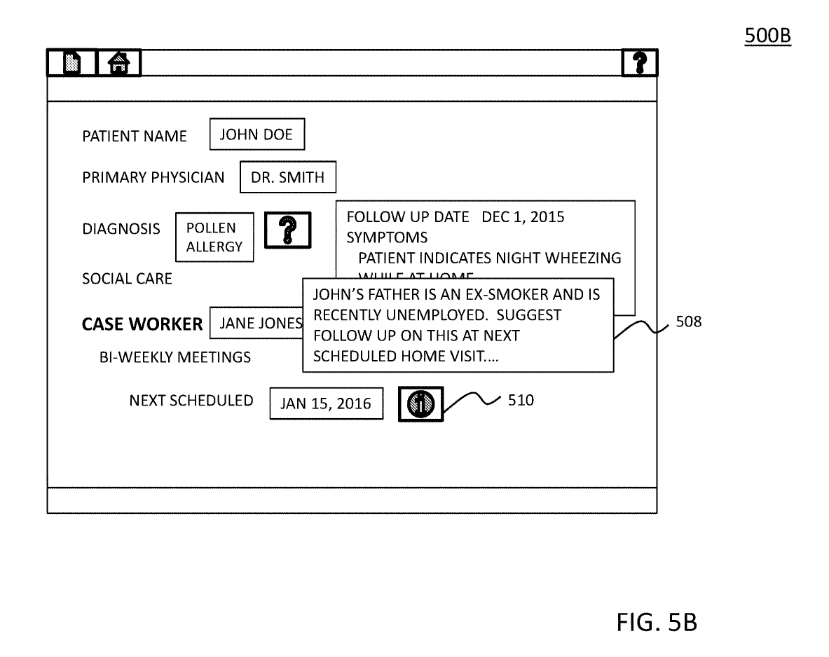

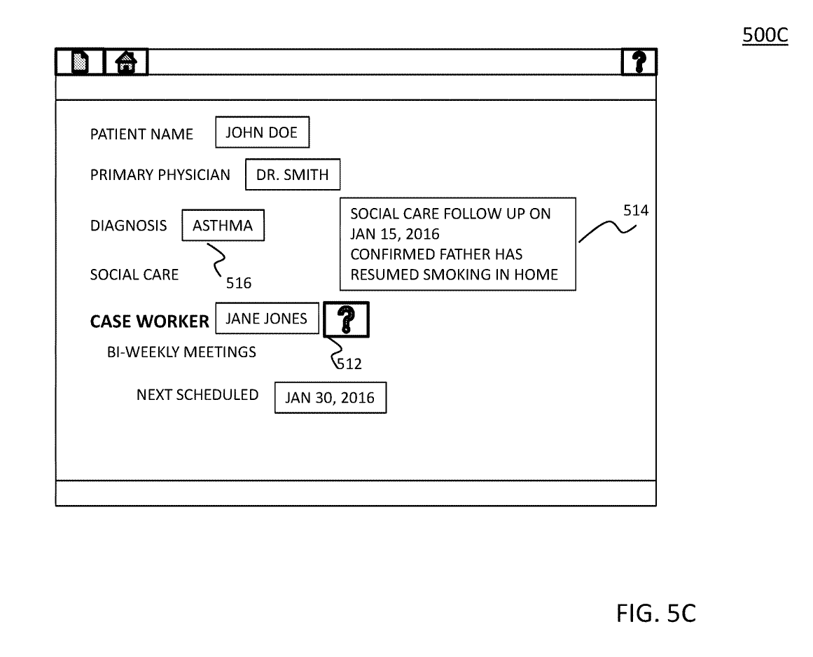

In block 402, it is determined that a data element in a dataset under review is potentially in non-conformance with other data in the dataset. The potential non-conformance may be determined based on a discrepancy in a pattern noted in the dataset with respect to the data element. A user interface screen 500A is shown in FIG. 5, which illustrates a sample data structure that can be viewed by one or more domain experts. As can be seen in FIG. 5A, the review involves a data structure for a patient in which details of a diagnosis POLLEN ALLERGY 502, as the data element, are under consideration. Upon reviewing the details of the diagnosis POLLEN ALLERGY 502, other data in the dataset for this patient appear to conflict with the diagnosis. For instance, the collective symptoms of wheezing at night and only at home in window 504 do not comport with the diagnosis of ASTHMA.

In block 404, the data structure containing the data element is annotated to indicate the potential non-conformance. As shown in FIG. 5A, by way of non-limiting example, the annotation may be implemented as an icon 506 directly adjacent to the data element in question. The icon 506 may serve to notify domain experts of the potential non-conformance and to take appropriate actions.

In block 406, users are provided, via a user interface, access to the data structure. As indicated above, the users collectively include domain experts for each of the multiple knowledge domains. In an embodiment, the access may be provided by a login procedure, such that a domain expert views the data structure upon logging into the user interface via a user device 304. In another embodiment, the access may be provided through active notifications, as will be described further herein.

In block 408, one or more domain experts who have reviewed the data that triggered the potential non-conformance may input a proposed course of action, which is mapped to the data element in the data structure via the application. As shown in FIG. 5B, a user interface screen 500B illustrates a data structure including a proposed course of action directed to a case worker, which is entered in a window 508. The proposed course of action is determined based on existing knowledge that may be uniquely associated with one domain expert (e.g., the case worker, as reflected in window 508) and is easily shared with other domain experts through the interactive data structure in order to provide a more holistic view of the patient. In addition to this tacit knowledge, the domain expert (e.g., case worker) offers a proposed action that is configured to derive additional information that may either corroborate the non-conformance or serve to negate the non-conformance. In an embodiment, the course of action can include a number of different strategies. For example, the proposed course of action may include a directive from one domain expert to collect or provide, by another domain expert, additional information. In another example, the proposed course of action may include an offer from one domain expert to collect additional information. If a domain expert has sufficient information to corroborate or negate the non-conformance, the domain expert may enter the information in lieu of the course of action. In an embodiment, if the domain expert enters a course of action, the application may annotate the data structure to indicate the course of action, which can serve to notify other domain experts of the suggested course of action. As shown in FIG. 5B, for example, because the course of action from window 508 relates to an upcoming home visit by a case worker, an icon 510 is placed directly adjacent to the date of next scheduled home visit. It is understood that the icon 510 or other indicator can be placed in any suitable location of the data structure (e.g., adjacent to the name of the domain expert who either offered/input the course of action, or who was designated by another domain expert to implement the course of action). Any domain expert who accesses the data structure may view the icon 510 and determine that a course of action has been input to the data structure.

The proposed course of action can also be computer-generated based on analysis of the dataset in view of the potential non-conforming data element. In an embodiment, the data structure is annotated (e.g., window 504) to indicate the portion of the other data in the dataset that provides supporting evidence of non-conformance, as well as information that can facilitate an appropriate action to take (e.g., using the symptoms in window 504 in conjunction with the case worker-associated next home visit information to suggest the collection of more information during that meeting). Thus, the application may be configured to generate the proposed course of action in response to the supporting evidence and associated information in the dataset.

In block 410, results of implementing the course of action are entered via the data structure. For example, as shown in FIG. 5C, a user interface screen 500C illustrates results of a home visit by a case worker via window 514 in which corroborating evidence that initial diagnosis of a pollen allergy may be in error. As shown in the window 514, there is evidence of other causes of the patient's symptoms that comport with these symptoms. The domain expert provides these results, and the data structure is annotated to reflect a follow up icon 512, which indicates that this information may be applied to existing data in the dataset to update the data element. Thus, in block 412, it is determined whether the results of the course of action corroborate the veracity of the non-conformance. If so, the data structure is updated at block 414 to bring the data element into conformance with the pattern identified from the other data. This may be implemented by a particular domain expert skilled in the particular subject of the data element, such as a physician. The domain expert, as shown in FIG. 5C, has updated the data element (i.e., diagnosis) to ASTHMA 516 based on the information resulting from the course of action and the other data in the dataset. However, if the results of the course of action do not corroborate the non-conformance (i.e., the results are either inconclusive or provide evidence that the data element actually conforms with the other data), the application may generate a request for another course of action in block 416 or may remove the indication or question of non-conformance from the data element in block 418 (e.g., if the potential non-conforming data element can be explained).

As indicated above with respect to block 406, the access to the user interface and data structure may be provided through active notifications. In an embodiment, the application may determine, from the data element and contextual information associated with the other data in the dataset, at least one knowledge domain that is associated with the data element. Using the example of FIGS. 5A-5C, the application views the dataset and the data element and determines since the case worker is scheduled to perform a home visit to the patient in the immediate future, and the physician has the domain expertise to address medical issues, the application may identify the social care domain and the medical care domain as the knowledge domains relevant to the course of action. The application may then annotate the data structure to indicate the knowledge domain(s). From this information, the application can identify (e.g., from the domain expert data in storage device 310, at least one domain expert (e.g., primary care physician and case worker assigned to the patient), and generate a request to participate in resolution of the potential non-conformance. The request can be sent to the domain experts through any communication means, such as email, text, phone, etc.

As indicated above, service-delivery datasets are used over long periods of time, to support a variety of practices and processes. Because of this, and because those interacting with them are experienced users, they will have an understanding of likely future use cases. For example, in the delivery of social care, there are a variety of use cases, such as home visits by a social worker, or regular visits by child protection workers, that may be associated with a particular service-delivery dataset.

Experienced users can leverage their knowledge of these use cases to suggest ways of resolving concerns in the service-delivery dataset. They may, for example, wish to indicate that during the next home visit, a social worker collect a particular type of information, or that during the next child protection meeting, certain questions be asked. Thus, in an embodiment, rather than identifying a non-conformance in a data element, the process may be configured to identify and address any concerns expressed by a domain expert. Indicating concerns within the service-delivery dataset may be implemented similar to the non-conformance processes above, e.g., by annotating the dataset so that the requested action resulting from the concern is made available to all who view that data and execute related workflows.

In addition, while the data structures of FIGS. 5A-5C illustrate sample datasets and potential non-conformances, as well as courses of actions and results, it will be understood that the data structures can be configured to receive and store many other types of information. For example, useful information in resolving a potential non-conformance can include a reason for marking the data element as a possible non-conformance, why resolving the non-conformance is important for the care of the patient, any items or actions related to the non-conformance that may relate to the non-conformance (e.g., depend on the non-conformance).

Courses of action that can be taken via the application may include sending an explicit request (e.g., email, SMS, voice) to a particular person, compute the importance or priority of resolving the non-conformance based on collective inputs from multiple domain experts, and identify the severity of the non-conformance and prioritize courses of action based on the severity.

In addition, system-wide evaluation and processing of the non-conformance processing described above can be implemented. For example, if a number of data elements from a particular dataset have associated non-conformances, there may be issues with their source (e.g., a form may be poorly designed causing individuals to enter erroneous information). If a number of data elements in a given dataset have associated non-conformances, the system can notify an administrator that the dataset may have issues. If data items that have associated non-conformances are used as input to an analytic engine for producing derived data, the derived data can be annotated as having a non-conformance. The system can also track the domain experts and corresponding actions implemented by the domain experts to determine which of them are more adept at associating non-conformances with data elements.

Technical effects and benefits include coordinated care delivery. The coordinated care delivery enables individuals having domain expertise across a multitude of different knowledge domains (a given individual possibly only having expertise in a single domain) to collaborate on the refinement of particular datasets when it is determined that any data in the datasets is incorrect, missing, or otherwise is believed to lack conformance with other data in the dataset. The coordinated care delivery processes provide an interface in which domain experts can input, view, update, and refine data in a dataset.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method, comprising:
determining, via a computer processor, that a data element in a dataset is potentially in non-conformance with other data in the dataset, the potential non-conformance determined based on a discrepancy in a pattern noted in the dataset with respect to the data element, the dataset spanning multiple knowledge domains;
annotating a data structure containing the data element to indicate the potential non-conformance;
providing, via a user interface of the computer processor, a plurality of users with access to the data structure, the users collectively comprising domain experts for each of the multiple knowledge domains;
determining, from the data element and contextual information associated with the other data in the dataset, at least one knowledge domain, from the multiple knowledge domains, that is associated with the data element;
annotating the data structure to indicate the at least one knowledge domain;
identifying at least one domain expert corresponding to the at least one knowledge domain;
generating a request to participate in resolution of the potential non-conformance; and
sending the request to the at least one domain expert, and wherein the at least one domain expert collects additional information.

2. The method of claim 1, further comprising:
receiving a proposed course of action from at least one of the domain experts, the proposed course of action mapped to the data element in the data structure; and
updating the data structure, via the computer processor, to include results received in response to execution of the proposed course of action.

3. The method of claim 2, wherein the proposed course of action includes at least one of:
a directive to collect, by another of the domain experts, additional data;
an offer to collect, by the at least one domain expert, additional data; and
production of information that explains the discrepancy to validate that the data element is in conformance.

4. The method of claim 2, further comprising annotating the data structure to indicate a portion of the other data in the dataset that provides supporting evidence of the non-conformance;
wherein the proposed course of action is determined in response to the supporting evidence.

5. The method of claim 2, further comprising annotating the data structure to indicate user-inputted supporting evidence of the potential non-conformance;
wherein the proposed course of action is determined by the domain expert after reviewing the user-inputted supporting evidence.

6. The method of claim 2, further comprising:
upon determining the results of the execution of the proposed course of action provide corroborating evidence that the data element is not in conformance, updating the data structure to bring the data element into conformance with the pattern identified from the other data.

7. The method of claim 2, further comprising:
upon determining the results of the execution of the proposed course of action do not provide corroborating evidence that the data element is not in conformance, generating a request for another proposed course of action.

8. (canceled)

9. A system, comprising:
a memory having computer readable instructions; and
a processor for executing the computer readable instructions, the computer readable instructions including:
determining that a data element in a dataset is potentially in non-conformance with other data in the dataset, the potential non-conformance determined based on a discrepancy in a pattern noted in the dataset with respect to the data element, the dataset spanning multiple knowledge domains;
annotating a data structure containing the data element to indicate the potential non-conformance;
providing, via a user interface of the processor, a plurality of users with access to the data structure, the users collectively comprising domain experts for each of the multiple knowledge domains;
determining, from the data element and contextual information associated with the other data in the dataset, at least one knowledge domain, from the multiple knowledge domains, that is associated with the data element;
annotating the data structure to indicate the at least one knowledge domain;
identifying at least one domain expert corresponding to the at least one knowledge domain;
generating a request to participate in resolution of the potential non-conformance; and
sending the request to the at least one domain expert, and wherein the at least one domain expert collects additional information.

10. The system of claim 9, wherein the computer readable instructions further include:
receiving a proposed course of action from at least one of the domain experts, the proposed course of action mapped to the data element in the data structure; and
updating the data structure to include results received in response to execution of the proposed course of action.

11. The system of claim 10, wherein the proposed course of action includes at least one of:
a directive to collect, by another of the domain experts, additional data;
an offer to collect, by the at least one domain expert, additional data; and
production of information that explains the discrepancy to validate that the data element is in conformance.

12. The system of claim 10, wherein the computer readable instructions further include annotating the data structure to indicate a portion of the other data in the dataset that provides supporting evidence of the non-conformance;
wherein the proposed course of action is determined in response to the supporting evidence.

13. The system of claim 10, wherein the computer readable instructions further include annotating the data structure to indicate user-inputted supporting evidence of the potential non-conformance;
wherein the proposed course of action is determined by the domain expert after reviewing the user-inputted supporting evidence.

14. The system of claim 10, wherein the computer readable instructions further include:
upon determining the results of the execution of the proposed course of action provide corroborating evidence that the data element is not in conformance, updating the data structure to bring the data element into conformance with the pattern identified from the other data.

15. The system of claim 10, wherein the computer readable instructions further include:
upon determining the results of the execution of the proposed course of action do not provide corroborating evidence that the data element is not in conformance, generating a request for another proposed course of action.

16. (canceled)

17. A computer program product comprising a computer readable storage medium having program instructions embodied therewith, wherein the computer readable storage medium is not a transitory signal per se, the program instructions executable by a computer processor to cause the computer processor to perform a method comprising:
determining that a data element in a dataset is potentially in non-conformance with other data in the dataset, the potential non-conformance determined based on a discrepancy in a pattern noted in the dataset with respect to the data element, the dataset spanning multiple knowledge domains;
annotating a data structure containing the data element to indicate the potential non-conformance;
providing, via a user interface, a plurality of users with access to the data structure, the users collectively comprising domain experts for each of the multiple knowledge domains;
determining, from the data element and contextual information associated with the other data in the dataset, at least one knowledge domain, from the multiple knowledge domains, that is associated with the data element;
annotating the data structure to indicate the at least one knowledge domain;
identifying at least one domain expert corresponding to the at least one knowledge domain;
generating a request to participate in resolution of the potential non-conformance; and
sending the request to the at least one domain expert, and wherein the at least one domain expert collects additional information.

18. The computer program product of claim 17, wherein the program instructions further cause the computer processor to perform:
receiving a proposed course of action from at least one of the domain experts, the proposed course of action mapped to the data element in the data structure; and
updating the data structure, via the computer processor, to include results received in response to execution of the proposed course of action.

19. The computer program product of claim 18, wherein the proposed course of action includes at least one of:
a directive to collect, by another of the domain experts, additional data;
an offer to collect, by the at least one domain expert, additional data; and
production of information that explains the discrepancy to validate that the data element is in conformance.

20. The computer program product of claim 18, wherein the program instructions further cause the computer processor to perform annotating the data structure to indicate a portion of the other data in the dataset that provides supporting evidence of the non-conformance;
wherein the proposed course of action is determined in response to the supporting evidence.

21. The method of claim 1, wherein the contextual information includes a scheduled appointment between a domain expert and a subject individual corresponding to the data set.
